(19) United States
(12) Patent Application Publication
(10) Pub. No.: US 2026/0067437 A1
(43) Pub. Date: Mar. 5, 2026

(54) OBJECT INTERACTION METHOD FOR THREE-DIMENSIONAL SPACE, AND DISPLAY DEVICE

(71) Applicant: BOE Technology Group Co., Ltd., Beijing (CN)

(72) Inventors: Yaoyu LV, Beijing (CN); Hao ZHANG, Beijing (CN); Siyan MA, Beijing (CN); Yan LI, Beijing (CN); Haofei GUO, Beijing (CN)

(21) Appl. No.: 18/995,631

(22) PCT Filed: Mar. 27, 2023
(86) PCT No.: PCT/CN2023/084089

§ 371 Date: Nov. 11, 2025

(51) Int. Cl. H04N 13/106; G06T 7/20; H04N 13/00; H04N 13/302

(52) U.S. Cl. CPC H04N 13/106; G06T 7/20; H04N 13/302; G06T 2207/30241; H04N 2013/0085

(57) ABSTRACT

An object interaction method of stereoscopic space and a display device, to constrain the interaction behavior of interactive objects, and effectively improve the false triggering problem generated during interaction in the stereoscopic space. The method includes: collecting interaction information between an object and display content in an interactive stereoscopic space, the interaction information representing a behavior trajectory of an interaction behavior between the object and the display content; extracting key point information of the object in different interaction stages from the interaction information, the key point information being used to reflect a behavior feature of the interaction behavior; and determining whether the interaction behavior of the object is valid according to the key point information.

### CROSS REFERENCE TO RELATED APPLICATION

This application is a national phase entry under 35 U.S.C. § 371 of International Application No. PCT/CN2023/084089, filed on Mar. 27, 2023, the entire content of which is incorporated herein by reference.

### TECHNICAL FIELD

The disclosure relates to the field of computer vision technology, and in particular to an object interaction method of stereoscopic space and a display device.

### BACKGROUND

Traditional displays are flat-panel displays for which touch interaction is typically used. A device such as a VR/AR device provides a user with an interactive stereoscopic space with a full field of view, and gesture interaction is typically used for the VR/AR device. A naked-eye 3D display screen provides a user with an interactive stereoscopic space with a certain depth, and the position and size of this space are fixed.

When a user performs gesture interaction with display content in the interactive stereoscopic space, the phenomenon of false triggering is prone to occur because the display content presents many interactive elements at the same time.

### SUMMARY

Embodiments of the disclosure provide an object interaction method of stereoscopic space, including:
collecting interaction information between an object and display content in an interactive stereoscopic space, where the interaction information represents a behavior trajectory of an interaction behavior between the object and the display content;
extracting key point information of the object in different interaction stages from the interaction information, where the key point information is used to reflect a behavior feature of the interaction behavior; and
determining whether the interaction behavior of the object is valid according to the key point information.

In some embodiments, the interaction information includes at least two of:
a first parameter set of the object in an interaction preparation stage, where the first parameter set includes hovering start information of the object;
a second parameter set of the object in an interaction occurrence stage, where the second parameter set includes collision information of the object and the display content, a moving direction and a moving speed of the object relative to the display content, and a changing behavior of the object during interaction; and
a third parameter set of the object in an interaction ending stage, where the third parameter set includes turning-back trajectory information of the object after collision ends.

In some embodiments, the extracting the key point information of the object in different interaction stages from the interaction information, includes:
extracting at least one of a hovering start position and a hovering start duration from the first parameter set;
extracting at least one of a collision start position, a depth change during collision, a minimum-depth position of movement during collision, a farthest position of movement during collision, a collision end position, a movement end position, a collision duration, the moving direction, the moving speed, and a changing behavior of the object at the minimum-depth position from the second parameter set; where the depth change represents a change in distance of the object from a display screen during collision; and
extracting a hovering end position and an interaction duration from the third parameter set, where the hovering end position is a position of the object closest to the hovering start position in a turning-back trajectory after collision ends.

In some embodiments, the determining whether the interaction behavior of the object is valid according to the key point information, includes:
determining an interaction category of the interaction behavior of the object according to the interaction information;
extracting key point information corresponding to the interaction category in different interaction stages from the interaction information; and
determining whether the interaction behavior of the object is valid according to whether the extracted key point information satisfies a constraint condition corresponding to the interaction category.

In some embodiments, the determining whether the interaction behavior of the object is valid according to whether the extracted key point information satisfies the constraint condition corresponding to the interaction category, includes:
determining a first behavior parameter and a second behavior parameter according to the key point information, where the first behavior parameter represents a parameter for position constraint on the interaction behavior from a spatial dimension, and the second behavior parameter represents a parameter for time constraint on the interaction behavior from a time dimension; and
determining whether the interaction behavior of the object is valid according to whether the first behavior parameter and the second behavior parameter satisfy the constraint condition.

In some embodiments, if the interaction category includes collision interaction, the extracted key point information includes:
a hovering start position and a hovering start duration;
at least two of a collision start position, a depth change during collision, a minimum-depth position of movement during collision, a farthest position of movement during collision, a collision end position, and a collision duration; and
a hovering end position and an interaction duration.

In some embodiments, if the collision interaction is single click or long press, whether the interaction behavior of the object is valid is determined by:
determining a collision distance according to the collision start position and the collision end position;
determining a hovering distance according to the hovering start position and the hovering end position; and
determining that the interaction behavior of the object is valid if the depth change during collision, the collision distance, the hovering distance, the hovering start duration, the collision duration and the interaction duration all satisfy the constraint condition of the single click or long press.

In some embodiments, if the collision interaction is double click, whether the interaction behavior of the object is valid is determined by:
determining a collision distance according to the collision start position and the collision end position;
determining a hovering distance according to the hovering start position and the hovering end position; and
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy the constraint condition of the double click.

In some embodiments, if the collision interaction is zoom, whether the interaction behavior of the object is valid is determined by:
determining a first hovering start position, a first collision start position, a first farthest position of movement during collision, a first depth change during collision and a first hovering start duration according to an interaction behavior corresponding to a finger of the object;
determining a second hovering start position, a second collision start position, a second farthest position of movement during collision, a second depth change during collision and a second hovering start duration according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration and the second hovering start duration all satisfy the constraint condition of the zoom.

In some embodiments, if the interaction category includes swipe interaction, the extracted key point information includes:
a hovering start position, a hovering start duration, a moving direction, a moving speed, a moving end position and an interaction duration.

In some embodiments, whether the interaction behavior of the object is valid is determined by:
determining a swipe distance according to the hovering start position and the moving end position; and
determining that the interaction behavior of the object is valid if the moving direction, the moving speed, the swipe distance, the interaction duration and the hovering start duration all satisfy the constraint condition of the swipe interaction.

In some embodiments, if the interaction category includes grab-and-release interaction, the extracted key point information includes:
a hovering start duration, a changing behavior of the object at a minimum-depth position of movement during collision, and an interaction duration.

In some embodiments, whether the interaction behavior of the object is valid is determined by:
determining that the interaction behavior of the object is valid if the interaction duration, the hovering start duration and the changing behavior of the object all satisfy the constraint condition of the grab-and-release interaction.

Embodiments of the disclosure provide a display device, including a display screen and a controller, where:
the display screen is configured to display content in an interactive stereoscopic space; and
the controller is configured to:
collect interaction information between an object and display content in an interactive stereoscopic space, where the interaction information represents a behavior trajectory of an interaction behavior between the object and the display content;
extract key point information of the object in different interaction stages from the interaction information, where the key point information is used to reflect a behavior feature of the interaction behavior; and
determine whether the interaction behavior of the object is valid according to the key point information.

In some embodiments, the interaction information includes at least two of:
a first parameter set of the object in an interaction preparation stage, where the first parameter set includes hovering start information of the object;
a second parameter set of the object in an interaction occurrence stage, where the second parameter set includes collision information of the object and the display content, a moving direction and a moving speed of the object relative to the display content, and a changing behavior of the object during interaction; and
a third parameter set of the object in an interaction ending stage, where the third parameter set includes turning-back trajectory information of the object after collision ends.

In some embodiments, the controller is configured to:
extract at least one of a hovering start position and a hovering start duration from the first parameter set;
extract at least one of a collision start position, a depth change during collision, a minimum-depth position of movement during collision, a farthest position of movement during collision, a collision end position, a movement end position, a collision duration, the moving direction, the moving speed, and a changing behavior of the object at the minimum-depth position from the second parameter set; where the depth change represents a change in distance of the object from a display screen during collision; and
extract a hovering end position and an interaction duration from the third parameter set, where the hovering end position is a position of the object closest to the hovering start position in a turning-back trajectory after collision ends.

In some embodiments, the controller is configured to:
determine an interaction category of the interaction behavior of the object according to the interaction information;
extract key point information corresponding to the interaction category in different interaction stages from the interaction information; and
determine whether the interaction behavior of the object is valid according to whether the extracted key point information satisfies a constraint condition corresponding to the interaction category.

In some embodiments, the controller is configured to:
determine a first behavior parameter and a second behavior parameter according to the key point information, where the first behavior parameter represents a parameter for position constraint on the interaction behavior from a spatial dimension, and the second behavior parameter represents a parameter for time constraint on the interaction behavior from a time dimension; and
determine whether the interaction behavior of the object is valid according to whether the first behavior parameter and the second behavior parameter satisfy the constraint condition.

In some embodiments, if the interaction category includes collision interaction, the extracted key point information includes:
a hovering start position and a hovering start duration;
at least two of a collision start position, a depth change during collision, a minimum-depth position of movement during collision, a farthest position of movement during collision, a collision end position, and a collision duration; and
a hovering end position and an interaction duration.

In some embodiments, if the collision interaction is single click or long press, the controller is configured to determine whether the interaction behavior of the object is valid by:
determining a collision distance according to the collision start position and the collision end position;
determining a hovering distance according to the hovering start position and the hovering end position; and
determining that the interaction behavior of the object is valid if the depth change during collision, the collision distance, the hovering distance, the hovering start duration, the collision duration and the interaction duration all satisfy the constraint condition of the single click or long press.

In some embodiments, if the collision interaction is double click, the controller is configured to determine whether the interaction behavior of the object is valid by:
determining a collision distance according to the collision start position and the collision end position;
determining a hovering distance according to the hovering start position and the hovering end position;
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy the constraint condition of the double click.

In some embodiments, if the collision interaction is zoom, the controller is configured to determine whether the interaction behavior of the object is valid by:
determining a first hovering start position, a first collision start position, a first farthest position of movement during collision, a first depth change during collision and a first hovering start duration according to an interaction behavior corresponding to a finger of the object;
determining a second hovering start position, a second collision start position, a second farthest position of movement during collision, a second depth change during collision and a second hovering start duration according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration and the second hovering start duration all satisfy the constraint condition of the zoom.

In some embodiments, if the interaction category includes swipe interaction, the extracted key point information includes:
a hovering start position, a hovering start duration, a moving direction, a moving speed, a moving end position and an interaction duration.

In some embodiments, the controller is configured to determine whether the interaction behavior of the object is valid by:
determining a swipe distance according to the hovering start position and the moving end position; and
determining that the interaction behavior of the object is valid if the moving direction, the moving speed, the swipe distance, the interaction duration and the hovering start duration all satisfy the constraint condition of the swipe interaction.

In some embodiments, if the interaction category includes grab-and-release interaction, the extracted key point information includes:
a hovering start duration, a changing behavior of the object at a minimum-depth position of movement during collision, and an interaction duration.

In some embodiments, the controller is configured to determine whether the interaction behavior of the object is valid by:
determining that the interaction behavior of the object is valid if the interaction duration, the hovering start duration and the changing behavior of the object all satisfy the constraint condition of the grab-and-release interaction.

Embodiments of the disclosure further provide an electronic device, including a processor and a memory. The memory is configured to store a program executable by the processor. The processor is configured to read the program in the memory and perform:
collecting interaction information between an object and display content in an interactive stereoscopic space, where the interaction information represents a behavior trajectory of an interaction behavior between the object and the display content;
extracting key point information of the object in different interaction stages from the interaction information, where the key point information is used to reflect a behavior feature of the interaction behavior; and
determining whether the interaction behavior of the object is valid according to the key point information.

Embodiments of the disclosure further provide an object interaction apparatus of stereoscopic space, including:
an information collection unit configured to collect interaction information between an object and display content in an interactive stereoscopic space, where the interaction information represents a behavior trajectory of an interaction behavior between the object and the display content;
an information extraction unit configured to extract key point information of the object in different interaction stages from the interaction information, where the key point information is used to reflect a behavior feature of the interaction behavior; and
a validity determining unit configured to determine whether the interaction behavior of the object is valid according to the key point information.

Embodiments of the disclosure further provide a computer storage medium storing a computer program thereon. The program implements the steps of the method described in the first aspect when executed by a processor.

The technical solution of the disclosure will be more clear and easy to understand in the description of the following embodiments.

### BRIEF DESCRIPTION OF DRAWINGS

In order to illustrate the technical solutions in the embodiments of the disclosure more clearly, the accompanying figures which need to be used in describing the embodiments will be introduced below briefly. Obviously the accompanying figures described below are only for some embodiments of the disclosure, and other accompanying figures can also be obtained by those ordinary skilled in the art according to these accompanying figures without creative labor.

FIG. 1 is a schematic diagram of an interactive scene with a gesture as an object according to embodiments of the disclosure.

FIG. 2A is a schematic diagram of an error interaction feedback according to embodiments of the disclosure.

FIG. 2B is a schematic diagram of an error interaction feedback according to embodiments of the disclosure.

FIG. 3 is an implementation flowchart of an object interaction method of stereoscopic space according to embodiments of the disclosure.

FIG. 4 is a schematic diagram of interaction in which the object is a gesture according to embodiments of the disclosure.

FIG. 5 is a schematic diagram of an interaction trajectory of a single-click gesture according to embodiments of the disclosure.

FIG. 6 is a schematic diagram of an interaction trajectory of a long-press gesture according to embodiments of the disclosure.

FIG. 7 is a schematic diagram of an interaction trajectory of a double-click gesture according to embodiments of the disclosure.

FIG. 8 is a schematic diagram of an interaction trajectory of a zoom gesture according to embodiments of the disclosure.

FIG. 9 is a schematic diagram of an interaction trajectory of a swipe gesture according to embodiments of the disclosure.

FIG. 10 is a schematic diagram of an interaction trajectory of a grab-and-release gesture according to embodiments of the disclosure.

FIG. 11 is a schematic diagram of a naked-eye 3D display device according to embodiments of the disclosure.

FIG. 12 is a schematic diagram of a display device according to embodiments of the disclosure.

FIG. 13 is a schematic diagram of an electronic device according to embodiments of the disclosure.

FIG. 14 is a schematic diagram of an object interaction apparatus in a stereoscopic space according to embodiments of the disclosure.

### DETAILED DESCRIPTION

In order to make the objects, technical solutions and advantages of the disclosure clearer, the disclosure will be further illustrated below in details with reference to the accompanying figures. Obviously the described embodiments are merely a part of the embodiments of the disclosure but not all the embodiments. Based upon the embodiments in the disclosure, all of other embodiments obtained by those ordinary skilled in the art without creative work pertain to the protection scope of the disclosure.

The term “and/or” in the embodiments of the disclosure describes the relationships of associated objects, indicating that there may be three relationships, for example, A and/or B may represent: only A, both A and B, and only B. The character “/” generally indicates that the associated objects have a kind of “or” relationship.

The application scenarios described in the embodiments of the disclosure are intended to illustrate the technical solutions of the embodiments of the disclosure more clearly, and do not constitute a limitation on the technical solutions provided in the embodiments of the disclosure. As can be known by those ordinary skilled in the art, with the appearance of new application scenarios, the technical solutions provided in the embodiments of the disclosure are also applicable to solve similar technical problems. Here, in the description of the disclosure, “multiple” means two or more unless otherwise specified.

At present, the interactive function based on the gesture recognition technology is a major research hotspot, and has applications in the VR/AR, naked-eye 3D display and other fields. The core thereof is to collect the user gesture information through a sensor device such as camera, identify gestures through relevant recognition and classification algorithms, and assign different semantic information to different gestures, to realize different interactive functions. A traditional display is a flat-panel display for which touch interaction is typically used. A device such as a VR/AR device provides a user with an interactive stereoscopic space with a full field of view, and gesture interaction is typically used for the VR/AR device. Unlike the two described above, a naked-eye 3D display screen provides a user with an interactive stereoscopic space with a certain depth, and the position and size of this space are fixed. When the user uses a naked hand for gesture interaction, he/she tends to interact through a simple gesture such as clicking, grasping or swiping, which is more in line with the user's daily operating habits.

It should be noted that interaction between the gesture and 3D content needs to be realized by cooperation of the gesture and 3D content. At the content level, a general and easy-to-understand control needs to be provided. The control has a pre-set behavior or function after being triggered. Before or when or after the control is triggered, there will be an interactive feedback effect such as material, color, brightness, sound, etc., to inform the user of the current interaction status. Moreover, it is more important that the control itself contains position information. Only when the position of the interaction gesture coincides with the position of the control, it is considered that they have collided and the interaction effect of this control can be triggered. In terms of content, the project has mainly developed 2D multi-layer interface interactive applications and 3D model interactive applications. At the gesture level, different interaction effects can be achieved by analyzing the position, category, action, speed and other information of the user's gesture combined with the position of the content and other information. Common interaction gestures include: single click, long press, double click, zoom (scaling), swipe (sliding), grab and release, etc. These gestures can be distinguished by different gesture categories, collision time between gesture and content, number of collisions, number of collision points and other different parameters.

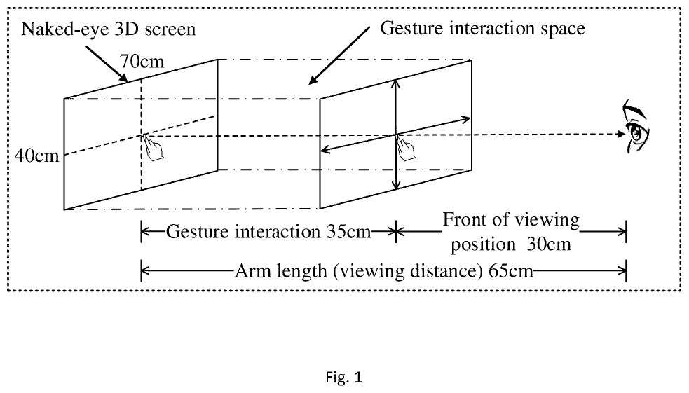

Firstly, the scene of interaction based on the interactive stereoscopic space involved in the embodiments will be briefly described. As shown in FIG. 1, the embodiments provide a schematic diagram of an interaction scene with a gesture as an object. Taking a 32-inch naked-eye 3D display device at desktop level as an example, the interaction effect between a naked hand and display content is debugged. The screen size of the naked-eye 3D display device is w×h (width×height)=70 cm×40 cm. Considering that the length of an adult's single arm is 65 cm and the user watches at 65 cm in front of the screen, the gesture needs to be at 30 cm away from the eyes so as not to block the line of sight during gesture interaction. Therefore, the size of the interactive stereoscopic space can be set to: 70 cm×40 cm×35 cm. During implementation, a plurality of cameras may be integrated at the screen frame to capture the position and action of a gesture in the interactive stereoscopic space of the screen to achieve naked-hand interaction. By adjusting the shooting angles of the cameras, the field of view of the cameras can completely cover the interactive stereoscopic space, and the user can freely interact with 3D content using the naked hand.

Taking a gesture as an example, when the user uses the gesture to interact with the 2D multi-layer interface or 3D model part in the interactive stereoscopic space, the content may simultaneously present more interactive elements at the same time, and these elements are distributed at different positions or different depths in the interactive stereoscopic space. The possible interaction problems are as follows.
Problem 1) If the user wants to interact with a content element inside, the gesture may collide with another element in the outer layer while the gesture is extending from the outer layer to the inside, thus triggering the error interaction effect.

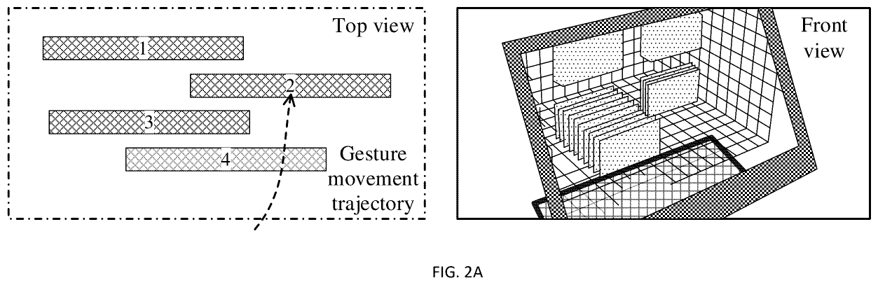

During actual interaction, the user usually extends his hand into the interactive stereoscopic space from the front. For the interaction of 2D multi-layer interface or the interaction of 3D model part, more interactive elements are simultaneously presented in terms of content at the same time, and these elements are distributed in different positions or depths. Then, during interaction, the user originally wants to interact with an element inside, but he collides with the element(s) in the outer layer(s) in the extending process of the gesture, thereby triggering an error interaction. As shown in FIG. 2A, the embodiments provide a schematic diagram of an error interaction feedback. The user wants to interact with the content element 2, and the gesture collides with the content element 4 during the movement. At this time, the error interaction feedback of the content element 4 will be triggered.
Problem 2) When the gesture is waved randomly or back and forth in the interactive stereoscopic space, there may be a collision with the content or a swipe gesture may be triggered, thereby triggering an error interaction effect.

During actual interaction, the gesture may be randomly waved in the interactive stereoscopic space, and the user does not intend to interact with any content element. As a result, the gesture collides with the content, thereby triggering an error interaction; or the swipe gesture may be triggered during the random waving of the gesture in the space, thereby triggering the interaction effect of content switching, which is also wrong. As shown in FIG. 2B, the embodiments provide a schematic diagram of an error interaction feedback. When the gesture is waved randomly or back and forth in the interactive stereoscopic space, the gesture collides with the content element 4. Then, the interaction feedback of the content element 4 will be triggered, which is wrong and does not meet the user's interaction expectation.

In order to solve the false triggering phenomenon of the user during gesture interaction, the embodiments provide an object interaction method of stereoscopic space. The key point information in the behavior trajectory of an object's interaction behavior is extracted to judge whether the interaction behavior is valid, and the interaction process is analyzed and refined. It can be judged whether the interaction behavior is valid according to different characteristics of the interaction behavior generated in different interaction stages. Taking the object being a gesture as an example, different gesture interaction processes are analyzed and refined, and corresponding parameters are set for different gesture interaction processes to perform conditional constraints, so as to prevent false triggering in the gesture interaction process and ensure the accuracy of gesture interaction. In the object interaction method provided by the embodiments, the idea of determining the valid interaction is: constraining parameters such as interaction position and interaction time corresponding to different interaction stages, thereby determining the valid interaction and preventing the false triggering phenomenon caused by the gesture during interaction.

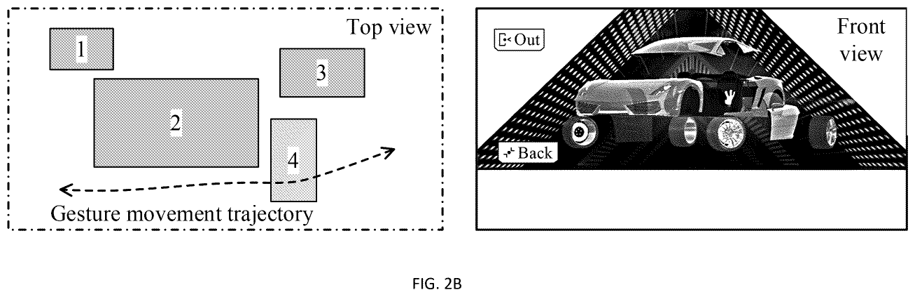

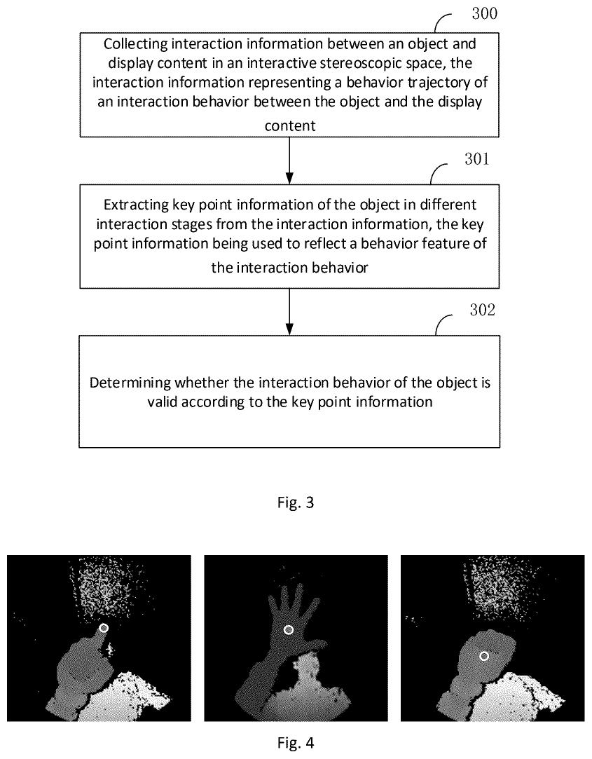

As shown in FIG. 3, an implementation process of the object interaction method of stereoscopic space provided by the embodiments is as follows.

Step 300: collecting interaction information between an object and display content in an interactive stereoscopic space. The interaction information represents a behavior trajectory of an interaction behavior between the object and the display content.

In some embodiments, the interactive stereoscopic space in the embodiments is determined based on the stereoscopic space that the display device can display. During implementation, the position and size of the interactive stereoscopic space can also be set according to the actual application scene. For example, when the actual operation scene is the stereoscopic space of a naked-eye 3D display screen, a smaller interactive stereoscopic space can be set based on the fact that the user can achieve interaction within a smaller range through gestures. When the actual operation scene is an AR/VR interaction scene, a larger interactive stereoscopic space can be set to facilitate all-round interaction.

In some embodiments, the object in the embodiments includes but is not limited to a finger, a palm, a hand, a joint, an arm, a leg, a foot, or any other operable body part. The object in the embodiments includes but is not limited to a human, a robot, an animal, or any other object with controllable property, which is not limited too much in the embodiments.

In some embodiments, the display content in the embodiments is 3D content or multi-layer 2D content. It should be noted that, when the display content is a 2D plane, the 2D plane actually has a certain thickness when displayed, rather than a completely two-dimensional plane. In this way, the real scene can be restored as much as possible to provide the user with a better interactive experience.

In some embodiments, the interaction information in the embodiments represents the behavior trajectory corresponding to the interaction behavior generated between the object and the display content during interaction, and includes but is not limited to at least two of the following items.
Item 1) A first parameter set of the object in an interaction preparation stage. The first parameter set includes hovering start information of the object.

In some embodiments, the hovering start information in the embodiments includes but is not limited to at least one of a hovering start position, a hovering start moment and a hovering start duration.

In some embodiments, when the hovering start position is located in the interactive stereoscopic space and the hovering start duration is less than a preset value, the interaction behavior of the object in the interaction preparation stage is valid.

In implementations, hovering refers to a state when the object enters the interactive stereoscopic space before interaction but does not touch the display content. Usually, the hovering position should be in the interactive stereoscopic space, and the hovering duration should comply with the user's interaction habits.
Item 2) A second parameter set of the object in an interaction occurrence stage. The second parameter set includes collision information of the object and the display content, a moving direction and a moving speed of the object relative to the display content, and a changing behavior of the object during interaction.

In implementations, collision refers to a state generated by the contact between the object and the display content when the object operates the display content.

In some embodiments, the collision information between the object and the display content in the embodiments refers to parameter information during the collision between the object and the display content, and includes but is not limited to any one or more of:
a collision start position, a depth change during collision, a minimum-depth position of movement during collision, a farthest position of movement during collision, a collision end position, a movement end position, a collision duration, a moving direction, a moving speed, and a changing behavior of the object at the minimum-depth position.

Here, the depth change represents a change in distance of the object from the display screen during the collision process. The smaller the depth, the smaller the distance; and the larger the depth, the larger the distance.
Item 3) A third parameter set of the object in an interaction ending stage. The third parameter set includes turning-back trajectory information of the object after collision ends.

In some embodiments, the turning-back trajectory information in the embodiments includes but is not limited to at least one of hovering end information and an interaction duration.

The hovering end information includes but is not limited to at least one of a hovering end position and a hovering end moment.

Step 301: extracting key point information of the object in different interaction stages from the interaction information. The key point information is used to reflect a behavior feature of the interaction behavior.

In some embodiments, the times (moments) and positions for generating the interaction behavior in different interaction stages are different.

In some embodiments, the key point information of different interaction stages extracted from the behavior trajectory of the interaction behavior of the object includes key point information in the first parameter set in the interaction preparation stage, the second parameter set in the interaction occurrence stage, and the third parameter set in the interaction ending stage. The step of extracting the key point information includes but is not limited to any one or more of:
extracting at least one of a hovering start position, a hovering start moment and a hovering start duration from the first parameter set;
extracting at least one of a collision start position, a depth change during collision, a minimum-depth position of movement during collision, a farthest position of movement during collision, a collision end position, a movement end position, a collision duration, a moving direction, a moving speed, and a changing behavior of the object at the minimum-depth position from the second parameter set; where the depth change represents a change in distance of the object from a display screen during collision; and
extracting a hovering end position and an interaction duration from the third parameter set, where the hovering end position is a position of the object closest to the hovering start position in a turning-back trajectory after collision ends. The interaction duration indicates the duration used for the complete interaction process between the object and the display content.

It should be noted that, taking the object being a hand as an example, the behavior feature of the interaction behavior in the gesture interaction process is analyzed and refined as follows.

### (1) the First Parameter Set in the Interaction Preparation Phase

In implementations, there is usually hovering preparation in the interaction preparation stage, and two parameters are extracted at this time: the hovering start position, the hovering start moment and the hovering start duration. The hovering start position and hovering start moment are used to prepare for subsequent judgment, and the hovering start duration is used to judge whether the user is preparing to interact with the display content or waving around randomly in the interactive space. Generally, the hovering start position is required to be within the interactive stereoscopic space, and the hovering start duration must conform to the user's interaction habits.

### (2) the Second Parameter Set in the Interaction Occurrence Stage

In implementations, the key point information collected in the interaction occurrence stage includes any one or more of the following.
2a. When the gesture collides with the display content, the collision start position is extracted to prepare for the judgment in the subsequent step.
2b. After the gesture collides with the display content, the collision point (interaction point) between the gesture and the display content reaches the minimum depth at a certain moment. At this time, the minimum-depth position of movement of the gesture during the collision is extracted to prepare for the judgment in the subsequent step.
2c. When the gesture collides with the display content continuously, the collision duration is extracted. This parameter can be used to judge whether the user has performed a single-click gesture or a long-press gesture. The threshold of the collision duration must conform to the user's interaction habits.
2d. If another collision is detected during the continuous collision between the gesture and the display content, the collision start position of the other collision is extracted. When the distance between the collision start positions respectively corresponding to the two collisions is relatively large, the interaction is considered to be valid and can be considered as a zoom gesture. The zoom ratio is proportional to the change in the distance between the two collision start positions.
2e. When the interaction behavior is a single collision and the collision between the gesture and the display content ends, the collision end position is extracted. The collision end position can be compared with the collision start position when the collision occurs. When the distance between the two positions is within a certain range, the interaction is considered to be valid. Generally, when the distance between the collision start position and the collision end position is relatively small, the gesture is considered as a single-click or long-press gesture. For the double-click gesture, there is at most one collision point at a certain moment, and there are two collisions within a period of time, that is, there are two collision start positions when the collisions occur, and there are two collision end positions when the collisions end. When the distance between any two of these four positions is within a certain range, the double-click interaction is considered to be valid. Moreover, there are two positions where the depth of the gesture interaction point reaches the minimum depths. When the distance between these two positions is within a certain range, the double-click interaction is considered to be valid.
2f. During the gesture interaction process, the moving speed and moving direction of the gesture are extracted, and can be used in cooperation with the hovering start position and the hovering start moment. After the gesture hovers at a certain position, the gesture moves towards a certain direction. When the moving speed is greater than a certain threshold, the gesture can be considered as a swipe gesture. In general, the hovering start position is required to be within the interaction space and there is no collision with any display content at the hovering start position, the hovering start duration and moving speed meet certain requirements, and the moving direction is left-right swipe or up-down swipe. The gesture can be considered as a left-right swipe gesture or an up-down swipe gesture. The left-right swipe can be designed to achieve the switching of display content or scene, and the up-down swipe can be designed to use the gesture to call out menu options and other functions.

### (3) the Third Parameter Set in the Interaction Ending Stage

In implementations, the gesture turns back after the collision between the gesture and the display content ends, the motion trajectory of the gesture when being turning back is tracked. When the distance between the final hovering position (i.e., the hovering end position) in the motion trajectory and the hovering start position is within a certain range, the interaction is considered to be valid.

In implementations, the interaction duration, i.e., the duration of a complete gesture interaction, may also be extracted. The timing starts from Step 1 of starting the hovering and ends when the final judgment of the interaction gesture is completed. Generally, when the interaction duration is within a certain period of time, the gesture interaction is considered to be valid. However, the zoom gesture is not restricted by this condition, and the time taken by the zoom process can be relatively long. After the content is zoomed and when the hovering time of any interaction point exceeds a threshold, the zoom gesture interaction ends, the zoom of the content is completed, and two interaction points stop colliding in sequence.

Step 302: determining whether the interaction behavior of the object is valid according to the key point information.

In some embodiments, the validity of the interaction behavior is determined by extracting the key point information related to the behavior feature of the interaction behavior. For example, the validity is determined by the following steps:
(1) determining an interaction category of the interaction behavior of the object according to the interaction information;
(2) extracting key point information corresponding to the interaction category in different interaction stages from the interaction information; and
(3) determining whether the interaction behavior of the object is valid according to whether the extracted key point information satisfies a constraint condition corresponding to the interaction category.

In some embodiments, whether the interaction behavior of the object is valid may also be determined by:
determining a first behavior parameter and a second behavior parameter according to the key point information, where the first behavior parameter represents a parameter for position constraint on the interaction behavior from a spatial dimension, and the second behavior parameter represents a parameter for time constraint on the interaction behavior from a time dimension; and
determining whether the interaction behavior of the object is valid according to whether the first behavior parameter and the second behavior parameter satisfy the constraint condition.

In some embodiments, the first behavior parameter includes but is not limited to: collision distance, hovering distance, depth change during collision, double-click distance, distance between two fingers, swipe distance, etc.

Here, when the interaction behavior includes single click, long press or double click, the collision distance is a distance between the collision start position and the collision end position; the hovering distance is a distance between the hovering start position and the hovering end position; and the double-click distance is a distance between the minimum-depth positions of movements during collisions with different moving trajectories.

When the interaction behavior includes zoom, the hovering distance is a distance between the first hovering start position and the second hovering start position, the collision distance is a distance between the first collision start position and the second collision start position, and the distance between two fingers is a distance between the first farthest position and the second farthest position. Here, the first hovering start position, the first collision start position, and the first farthest position of movement during collision are determined according to the interaction behavior corresponding to one finger of the object; and the second hovering start position, the second collision start position, and the second farthest position of movement during collision are determined according to the interaction behavior corresponding to another finger of the object.

When the interaction behavior includes swipe, the swipe distance is a distance between the hovering start position and the hovering end position.

The second behavior parameter includes but is not limited to: interaction duration, hovering start duration, collision duration, moving speed, moving direction, changing behavior of the object at the minimum-depth position of movement during collision, etc.

In implementations, the following seven commonly-used gestures are taken as examples to illustrate the process of determining a gesture as a valid interaction, so as to prevent false triggering during gesture interaction to thereby prevent generating the phenomenon of error feedback. Firstly, in term of algorithm, the gesture categories are divided into single-finger gesture, five-finger natural extension gesture, and five-finger natural bending gesture. The coordinates of the interaction points are extracted based on the three categories of gestures. As shown in FIG. 4, the embodiments provide a schematic diagram of interaction in which the object is a gesture. The single-finger gesture extracts the fingertip area as an interaction point, the five-finger natural extension gesture extracts the fingertip area and the palm area as interaction points, and the five-finger natural bending gesture extracts the gesture center area as an interaction point.

In some embodiments, if the interaction category includes collision interaction, the extracted key point information includes:
a hovering start position, a hovering start moment and a hovering start duration;
at least two of a collision start position, a depth change during collision, a minimum-depth position of movement during collision, a farthest position of movement during collision, a collision end position, and a collision duration; and
a hovering end position and a hovering end moment.

In some embodiments, if the collision interaction is single click or long press, whether the interaction behavior of the object is valid is determined by:
determining a collision distance according to the collision start position and the collision end position;
determining a hovering distance according to the hovering start position and the hovering end position; and
determining an interaction duration according to the hovering start moment and the hovering end moment; and
determining that the interaction behavior of the object is valid if the depth change during collision, the collision distance, the hovering distance, the hovering start duration, the collision duration and the interaction duration all satisfy constraint conditions of the single click or long press.

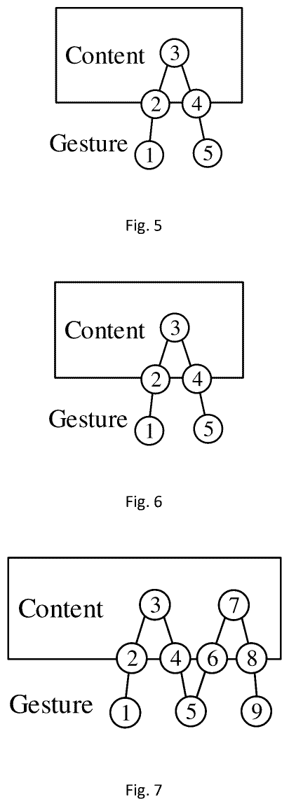

In implementations, taking a single-click gesture as an example, as shown in FIG. 5, the embodiments provide a schematic diagram of an interaction trajectory of the single-click gesture. The interaction process is as follows.

The gesture hovers at position 1, the coordinate of the hovering start position is p1, and the hovering start duration is t1.

A collision occurs at position 2, and the coordinate of the collision start position is p2; and the coordinate of the minimum-depth position 3 of movement during collision is p3. The gesture turns back from position 3 and ends the collision at position 4, the coordinate of the collision end position is p4, and the collision duration from position 2 to position 4 is t2. During the gesture turning-back process, the trajectory point closest to position 1 is position 5, that is, the coordinate of the hovering end position is p5.

In implementations, the judgment conditions for preventing false triggering of the gesture are as follows.

In terms of distance, the depth from p1 to p3 is reduced, the depth from p3 to p5 is restored, the straight-line distance from p1 to p5 is less than 1.8 cm, and the straight-line distance from p2 to p4 is less than 1 cm.

In terms of time, the hovering start duration t1 is greater than 0.3 s, and the collision duration t2 is less than 0.8 s.

When all the above conditions are met and the interaction duration for a complete interaction is less than 2 s, the single-click gesture is considered to be valid.

In implementations, taking a long-press gesture as an example, as shown in FIG. 6, the embodiments provide a schematic diagram of an interaction trajectory of the long-press gesture. The interaction process is as follows.

The gesture hovers at position 1, the coordinate of the hovering start position is p1, and the hovering start duration is t1.

A collision occurs at position 2, and the coordinate of the collision start position is p2. The coordinate of the minimum-depth position 3 of movement during collision is p3. The gesture turns back from position 3 and ends the collision at position 4. The coordinate of the collision end position is p4. The collision duration from position 2 to position 4 is t2. During the gesture turning-back process, the trajectory point closest to position 1 is position 5, that is, the coordinate of the hovering end position is p5.

In implementations, the judgment conditions for preventing false triggering of the gesture are as follows.

In terms of distance, the depth from p1 to p3 is reduced, the depth from p3 to p5 is restored, the straight-line distance from p1 to p5 is less than 1.8 cm, and the straight-line distance from p2 to p4 is less than 1 cm.

In terms of time, the hovering start duration t1 is greater than 0.3 s, and the collision duration t2 is greater than 0.8 s.

When all the above conditions are met and the interaction duration for a complete interaction is less than 2 s, the long-press gesture is considered to be valid. In implementations, the whole process is almost identical to that of the single-click gesture, except that the collision duration t2 is longer.

In some embodiments, if the collision interaction is double click, whether the interaction behavior of the object is valid is determined by:
determining a collision distance according to the collision start position and the collision end position;
determining a hovering distance according to the hovering start position and the hovering end position;
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy constraint conditions of the double click.

In implementations, taking a double-click gesture as an example, as shown in FIG. 7, the embodiments provide a schematic diagram of an interaction trajectory of the double-click gesture. The interaction process is as follows.

The gesture hovers at position 1, the coordinate of the first hovering start position is p1, and the hovering start duration is t1.

A collision occurs at position 2, and the coordinate of the first collision start position is p2. The coordinate of the minimum-depth position 3 of movement during the first collision is p3. The gesture turns back from position 3 and ends the collision at position 4. The coordinate of the first collision end position is p4. The collision duration from position 2 to position 4 is t2.

During the gesture turning-back process, the gesture trajectory turns back again at position 5. The coordinate of the second hovering start position is p5. The gesture produces a second collision at position 6. The coordinate of the second collision start position is p6. The coordinate of the minimum-depth position 7 of movement during the second collision is p7. The gesture turns back again from position 7 and ends the collision at position 8. The coordinate of the second collision end position is p8. The collision duration from position 6 to position 8 is t3.

During the gesture turning-back process, the point closest to position 1 is position 9, and the coordinate of the hovering end position is p9.

The judgment conditions for preventing false triggering of the gesture are as follows.

In terms of distance, the depth from p1 to p3 is reduced, the depth from p3 to p5 is restored, the depth from p5 to p7 is reduced, the depth from p7 to p9 is restored, the straight-line distance between any two of p1, p5 and p9 is less than 1.8 cm, the straight-line distance between any two of p2, p4, p6 and p8 is less than 1 cm, and the straight-line distance between p3 and p7 is less than 1 cm.

In terms of time, the hovering start duration t1 is greater than 0.3 s, and the collision durations t2 and t3 are both less than 0.8 s. When all the above conditions are met and the total duration for a complete interaction is less than 2 s, the double-click gesture is considered to be valid.

In some embodiments, if the collision interaction is zoom, whether the interaction behavior of the object is valid is determined by:
determining a first hovering start position, a first collision start position, a first farthest position of movement during collision, a first depth change during collision, a first hovering start duration, and a first farthest hovering duration for moving to the first farthest position according to an interaction behavior corresponding to a finger of the object;
determining a second hovering start position, a second collision start position, a second farthest position of movement during collision, a second depth change during collision, a second hovering start duration, and a second farthest hovering duration for moving to the second farthest position according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration, the second hovering start duration, the first farthest hovering duration and the second farthest hovering duration all satisfy constraint conditions of the zoom.

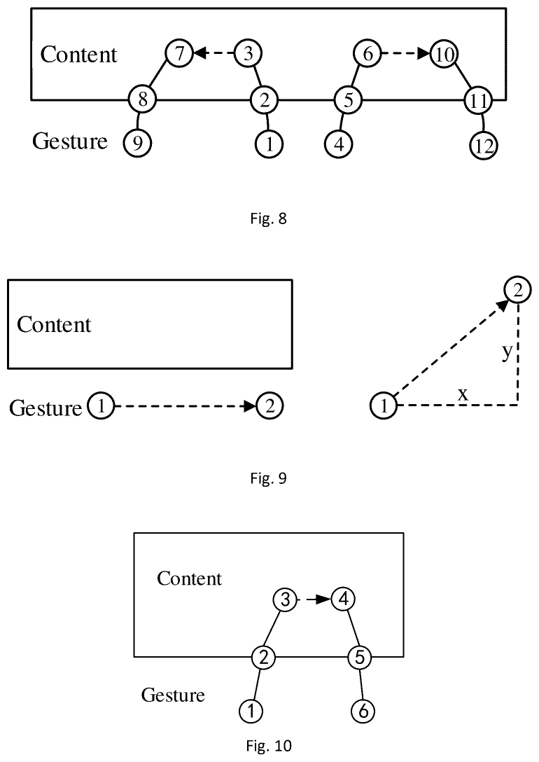

In implementations, taking a zoom gesture as an example, as shown in FIG. 8, the embodiments provide a schematic diagram of an interaction trajectory of the zoom gesture. The interaction process is as follows.

The gesture hovers at position 1, the coordinate of the first hovering start position is p1, and the hovering start duration is t1.

A collision occurs at position 2, and the coordinate of the first collision start position is p2. The coordinate of the minimum-depth position 3 of movement during the first collision is p3. During the continuous collision between the gesture and the content, a second collision between the gesture and the content is detected, the coordinate of the second collision start position is p5, and the coordinate of the minimum-depth position 6 of movement during the second collision is p6. At this time, the zoom ratio of the content is proportional to the distance from p3 to p6. If the coordinate of the first farthest position 7 to which the gesture moves from position 3 during the first collision is p7, and the coordinate of the second farthest position 10 to which the gesture moves from position 6 during the second collision is p10, then the change in distance is ∥(p7−p10)−(p3−p6)∥. Based on this, the content is zoomed. The two gestures hover at positions 7 and 10 for a duration of t2 after the zoom is completed. The two gestures end the collision in sequence and leave the content area.

The judgment conditions for preventing false triggering of the gesture are as follows.

In terms of distance, the depths from p1 to p3 and p4 to p6 are both reduced, the depths from p7 to p9 and p10 to p12 are both restored, and the straight-line distances from p1 to p4, p2 to p5, and p3 to p6 are all greater than 2 cm.

In terms of time, t1 is greater than 0.3 s, and t2 is greater than 0.3 s. When all the above conditions are met, the zoom gesture is considered to be valid.

In some embodiments, if the interaction category includes swipe interaction, the extracted key point information includes:
a hovering start position and a hovering start duration;
a moving direction and a moving speed; and
a moving end position and an interaction duration.

In some embodiments, if the interaction category includes swipe interaction, whether the interaction behavior of the object is valid is determined by:
determining a swipe distance according to the hovering start position and the moving end position; and
determining that the interaction behavior of the object is valid if the moving direction, the moving speed, the swipe distance, the interaction duration and the hovering start duration all satisfy constraint conditions of the swipe interaction.

In implementations, taking a swipe gesture as an example, as shown in FIG. 9, the embodiments provide a schematic diagram of an interaction trajectory of the swipe gesture. The interaction process is as follows.

The gesture hovers at position 1, the coordinate of the hovering start position is p1, and the hovering start duration is t1.

The gesture moves quickly from position 1 to position 2, the coordinate of the moving end position is p2, and the moving duration is t2. From the main view, the moving distance of the gesture position in the horizontal direction is x, and the moving distance of the gesture position in the vertical direction is y.

The judgment conditions for preventing false triggering of the gesture are as follows.

In terms of position, the distance from p1 to p2 is greater than 35 cm.

In terms of time, the hovering start duration t1 is greater than 0.3 s, and the moving duration is less than 0.14 s, that is, the moving speed of the gesture is greater than 2.5 m/s. When all the above conditions are met and the total duration for a complete interaction is less than 2 s, the swipe gesture is considered to be valid. Further, whether the swipe is swipe up and down or swipe left and right is determined according to x and y. If the value of x:y is greater than 2, the swipe is considered as swipe left and right. If the value of x:y is less than 0.5, the swipe is considered as swipe up and down.

In some embodiments, if the interaction category includes grab-and-release interaction, the extracted key point information includes:
a hovering start duration, a changing behavior of the object at the minimum-depth position of movement during collision, and an interaction duration.

In some embodiments, if the interaction category includes grab-and-release interaction, whether the interaction behavior of the object is valid is determined by:
determining that the interaction behavior of the object is valid if the interaction duration, the hovering start duration and the changing behavior of the object all satisfy constraint conditions of the grab-and-release interaction.

In implementations, as shown in FIG. 10, the embodiments provide a schematic diagram of an interaction trajectory of a grab-and-release gesture. Taking a grab gesture as an example, the interaction process is as follows.

The gesture is a five-finger natural extension gesture and hovers at position 1, the coordinate of the hovering start position is p1, and the hovering start duration is t1.

The gesture moves forward and generates a collision at position 2, and the coordinate of the minimum-depth position 3 of movement during the collision is p3.

The judgment conditions for preventing false triggering of the gesture are as follows.

The hovering start duration t1 is greater than 0.3 s, and the gesture changes from five-finger natural extension to five-finger natural bending at position 3. When all the above conditions are met and the total duration for a complete interaction is less than 2 s, the grab gesture is considered to be valid.

Taking a release gesture as an example, the interaction process is as follows.

After a model element is grabbed, the gesture is bound to the corresponding content and hovers at position 1, the coordinate of the hovering start position is p1, and the hovering start duration is t1.

The content moves with the gesture from position 3 to the target position 4. When the gesture changes from five-finger natural bending to five-finger natural extension at position 4, the gesture is unbound from the corresponding content, and the content no longer moves with the gesture. The gesture moves from position 4 to position 6, the gesture depth is restored, and the collision ends at position 5, completing the release operation.

The judgment conditions for preventing false triggering of the gesture are as follows.

The hovering start duration t1 is greater than 0.3 s, and the gesture changes from five-finger natural bending to five-finger natural extension at position 4. When all the above conditions are met and the total duration for a complete interaction is less than 2 s, the grab gesture is considered to be valid.

In the object interaction method of stereoscopic space provided by the embodiments, the gesture interaction process is analyzed and refined, and the relevant parameters such as hovering time, collision duration, collision position, number of collisions, collision distance, gesture moving speed and moving direction are constrained to prevent false triggering in the gesture interaction process and ensure the accuracy of gesture interaction.

Based on the same inventive concept, embodiments of the disclosure further provide a display device. Since this display device is the display device in the method in the embodiments of the disclosure and the principle of this display device to solve the problem is similar to that of the method, the implementations of this display device can refer to the implementations of the method, and the repeated description thereof will be omitted here.

It should be noted that the gesture interaction, as the most natural interaction way for humans, has irreplaceable advantages compared to other interaction ways. The display device provided in the embodiments includes but is not limited to a naked-eye 3D display device. A plurality of cameras can be integrated at the screen frame to capture the positions and actions of gestures in the interactive stereoscopic space of the screen, thereby implementing interactions of naked hands with 3D scenes and content. As shown in FIG. 11, the embodiments provide a schematic diagram of a naked-eye 3D display device. A plurality of cameras are integrated in the screen frame. In the figure, four cameras are integrated, and respectively located at four vertices of the screen frame to collect the gesture of the object in the interactive stereoscopic space. The display device in the embodiments can achieve the naked-hand or naked-finger interaction without the user having to carry a handle or wear data gloves, has the high user acceptance and also improves the value of the screen.

In some embodiments, more cameras may also be integrated at the screen frame to capture the positions and actions of gestures in the interactive stereoscopic space of the screen, to achieve naked-hand interaction. For example, five ToF cameras may be integrated, where one ToF camera is arranged at each of four top corners of the screen, and one ToF camera is arranged at the center below the screen. By adjusting the shooting angles of the cameras, the field of view of the five cameras can completely cover the interactive stereoscopic space, and the user can freely interact with 3D content using the naked hand. Here, the ToF (Time of Flight) is a distance measurement method. By measuring the “Time of Flight” of ultrasonic/microwave/light or other signals between a transmitter and a reflector, the distance therebetween is calculated. The ToF camera in the embodiments uses a ToF sensor that emits the infrared light or laser. Here, the generated light will bounce off any object and return to the sensor. According to the time difference between the light being emitted and the light returning to the sensor after being reflected by the object, the sensor can measure the distance between the object and the sensor, thereby collecting the position of the user's gesture in the interactive stereoscopic space. The gesture image is collected by the camera to identify the gesture action. Ultimately the position and action of the gesture during user interaction are obtained, implementing the naked-hand interaction with 3D content.

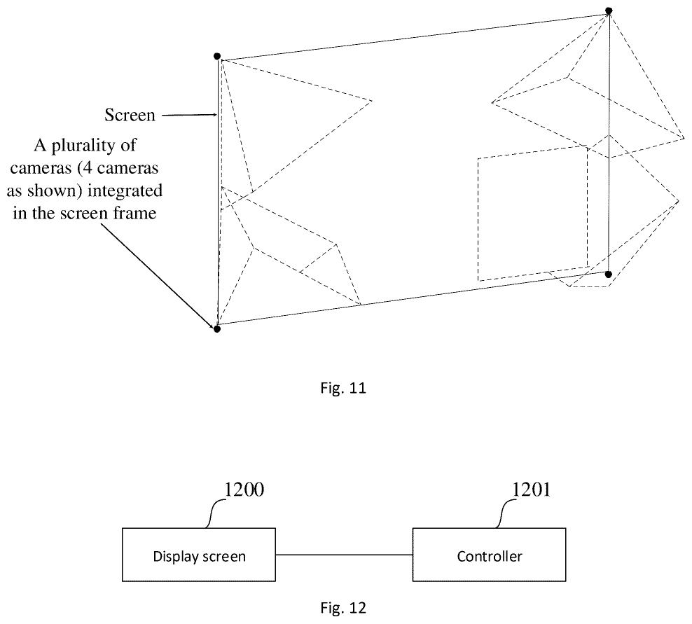

As shown in FIG. 12, the display device includes a display screen 1200 and a controller 1201.

The display screen 1200 is configured to display content in an interactive stereoscopic space.

The controller 1201 is configured to perform:
collecting interaction information between an object and display content in the interactive stereoscopic space, where the interaction information represents a behavior trajectory of an interaction behavior between the object and the display content;
extracting key point information of the object in different interaction stages from the interaction information, where the key point information is used to reflect a behavior feature of the interaction behavior; and
determining whether the interaction behavior of the object is valid according to the key point information.

In some embodiments, the interaction information includes at least two of:
a first parameter set of the object in an interaction preparation stage, where the first parameter set includes hovering start information of the object;
a second parameter set of the object in an interaction occurrence stage, where the second parameter set includes collision information of the object and the display content, a moving direction and a moving speed of the object relative to the display content, and a changing behavior of the object during interaction; and
a third parameter set of the object in an interaction ending stage, where the third parameter set includes turning-back trajectory information of the object after collision ends.

In some embodiments, the controller 1201 is configured to:
extract at least one of a hovering start position and a hovering start duration from the first parameter set;
extract at least one of a collision start position, a depth change during collision, a minimum-depth position of movement during collision, a farthest position of movement during collision, a collision end position, a movement end position, a collision duration, a moving direction, a moving speed, and a changing behavior of the object at the minimum-depth position from the second parameter set; where the depth change represents a change in distance of the object from a display screen during collision; and
extract a hovering end position and an interaction duration from the third parameter set, where the hovering end position is a position of the object closest to the hovering start position in a turning-back trajectory after collision ends.

In some embodiments, the controller 1201 is configured to:
determine an interaction category of the interaction behavior of the object according to the interaction information;
extract key point information corresponding to the interaction category in different interaction stages from the interaction information; and
determine whether the interaction behavior of the object is valid according to whether the extracted key point information satisfies a constraint condition corresponding to the interaction category.

In some embodiments, the controller 1201 is configured to:
determine a first behavior parameter and a second behavior parameter according to the key point information, where the first behavior parameter represents a parameter for position constraint on the interaction behavior from a spatial dimension, and the second behavior parameter represents a parameter for time constraint on the interaction behavior from a time dimension; and
determine whether the interaction behavior of the object is valid according to whether the first behavior parameter and the second behavior parameter satisfy the constraint condition.

In some embodiments, if the interaction category includes collision interaction, the extracted key point information includes:
a hovering start position and a hovering start duration;
at least two of a collision start position, a depth change during collision, a minimum-depth position of movement during collision, a farthest position of movement during collision, a collision end position, and a collision duration; and
a hovering end position and an interaction duration.

In some embodiments, if the collision interaction is single click or long press, the controller 1201 is configured to determine whether the interaction behavior of the object is valid by:
determining a collision distance according to the collision start position and the collision end position;
determining a hovering distance according to the hovering start position and the hovering end position; and
determining that the interaction behavior of the object is valid if the depth change during collision, the collision distance, the hovering distance, the hovering start duration, the collision duration and the interaction duration all satisfy constraint conditions of the single click or long press.

In some embodiments, if the collision interaction is double click, the controller 1201 is configured to determine whether the interaction behavior of the object is valid by:
determining a collision distance according to the collision start position and the collision end position;
determining a hovering distance according to the hovering start position and the hovering end position; and
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy constraint conditions of the double click.

In some embodiments, if the collision interaction is zoom, the controller 1201 is configured to determine whether the interaction behavior of the object is valid by:
determining a first hovering start position, a first collision start position, a first farthest position of movement during collision, a first depth change during collision and a first hovering start duration according to an interaction behavior corresponding to a finger of the object;
determining a second hovering start position, a second collision start position, a second farthest position of movement during collision, a second depth change during collision and a second hovering start duration according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration and the second hovering start duration all satisfy constraint conditions of the zoom.

In some embodiments, if the interaction category includes swipe interaction, the extracted key point information includes:
a hovering start position, a hovering start duration, a moving direction, a moving speed, a moving end position and an interaction duration.

In some embodiments, the controller 1201 is configured to determine whether the interaction behavior of the object is valid by:
determining a swipe distance according to the hovering start position and the moving end position; and
determining that the interaction behavior of the object is valid if the moving direction, the moving speed, the swipe distance, the interaction duration and the hovering start duration all satisfy constraint conditions of the swipe interaction.

In some embodiments, if the interaction category includes grab-and-release interaction, the extracted key point information includes:
a hovering start duration, a changing behavior of the object at the minimum-depth position of movement during collision, and an interaction duration.

In some embodiments, the controller 1201 is configured to determine whether the interaction behavior of the object is valid by:
determining that the interaction behavior of the object is valid if the interaction duration, the hovering start duration and the changing behavior of the object all satisfy constraint conditions of the grab-and-release interaction.

Based on the same inventive concept, embodiments of the disclosure further provide an electronic device. Since this electronic device is the electronic device in the method in the embodiments of the disclosure and the principle of this electronic device to solve the problem is similar to that of the method, the implementations of this electronic device can refer to the implementations of the method, and the repeated description thereof will be omitted here.

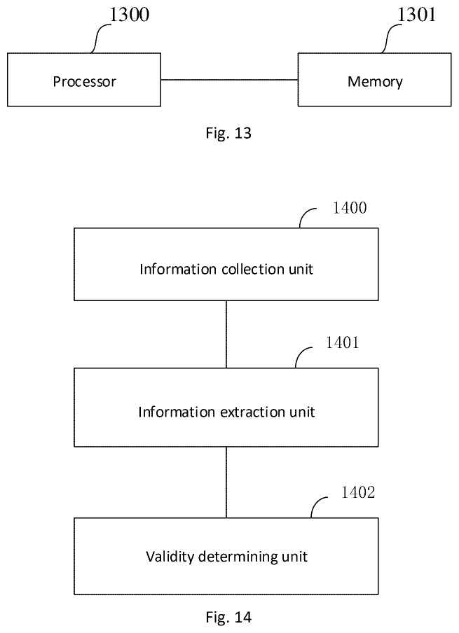

As shown in FIG. 13, the electronic device includes a processor 1300 and a memory 1301. The memory 1301 is configured to store a program executable by the processor 1300. The processor 1300 is configured to read the program in the memory 1301 and perform:
collecting interaction information between an object and display content in an interactive stereoscopic space, where the interaction information represents a behavior trajectory of an interaction behavior between the object and the display content;
extracting key point information of the object in different interaction stages from the interaction information, where the key point information is used to reflect a behavior feature of the interaction behavior; and
determining whether the interaction behavior of the object is valid according to the key point information.

In some embodiments, the interaction information includes at least two of:
a first parameter set of the object in an interaction preparation stage, where the first parameter set includes hovering start information of the object;
a second parameter set of the object in an interaction occurrence stage, where the second parameter set includes collision information of the object and the display content, a moving direction and a moving speed of the object relative to the display content, and a changing behavior of the object during interaction; and
a third parameter set of the object in an interaction ending stage, where the third parameter set includes turning-back trajectory information of the object after collision ends.

In some embodiments, the processor 1300 is configured to:
extract at least one of a hovering start position and a hovering start duration from the first parameter set;
extract at least one of a collision start position, a depth change during collision, a minimum-depth position of movement during collision, a farthest position of movement during collision, a collision end position, a movement end position, a collision duration, a moving direction, a moving speed, and a changing behavior of the object at the minimum-depth position from the second parameter set; where the depth change represents a change in distance of the object from a display screen during collision; and
extract a hovering end position and an interaction duration from the third parameter set, where the hovering end position is a position of the object closest to the hovering start position in a turning-back trajectory after collision ends.

In some embodiments, the processor 1300 is configured to:
determine an interaction category of the interaction behavior of the object according to the interaction information;
extract key point information corresponding to the interaction category in different interaction stages from the interaction information; and
determine whether the interaction behavior of the object is valid according to whether the extracted key point information satisfies a constraint condition corresponding to the interaction category.

In some embodiments, the processor 1300 is configured to:
determine a first behavior parameter and a second behavior parameter according to the key point information, where the first behavior parameter represents a parameter for position constraint on the interaction behavior from a spatial dimension, and the second behavior parameter represents a parameter for time constraint on the interaction behavior from a time dimension; and
determine whether the interaction behavior of the object is valid according to whether the first behavior parameter and the second behavior parameter satisfy the constraint condition.

In some embodiments, if the interaction category includes collision interaction, the extracted key point information includes:
a hovering start position and a hovering start duration;
at least two of a collision start position, a depth change during collision, a minimum-depth position of movement during collision, a farthest position of movement during collision, a collision end position, and a collision duration; and
a hovering end position and an interaction duration.

In some embodiments, if the collision interaction is single click or long press, the processor 1300 is configured to determine whether the interaction behavior of the object is valid by:
determining a collision distance according to the collision start position and the collision end position;
determining a hovering distance according to the hovering start position and the hovering end position; and
determining that the interaction behavior of the object is valid if the depth change during collision, the collision distance, the hovering distance, the hovering start duration, the collision duration and the interaction duration all satisfy constraint conditions of the single click or long press.

In some embodiments, if the collision interaction is double click, the processor 1300 is configured to determine whether the interaction behavior of the object is valid by:
determining a collision distance according to the collision start position and the collision end position;
determining a hovering distance according to the hovering start position and the hovering end position;
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy constraint conditions of the double click.

In some embodiments, if the collision interaction is zoom, the processor 1300 is configured to determine whether the interaction behavior of the object is valid by:
determining a first hovering start position, a first collision start position, a first farthest position of movement during collision, a first depth change during collision and a first hovering start duration according to an interaction behavior corresponding to a finger of the object;
determining a second hovering start position, a second collision start position, a second farthest position of movement during collision, a second depth change during collision and a second hovering start duration according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration and the second hovering start duration all satisfy constraint conditions of the zoom.

In some embodiments, if the interaction category includes swipe interaction, the extracted key point information includes:
a hovering start position, a hovering start duration, a moving direction, a moving speed, a moving end position and an interaction duration.

In some embodiments, the processor 1300 is configured to determine whether the interaction behavior of the object is valid by:
determining a swipe distance according to the hovering start position and the moving end position; and
determining that the interaction behavior of the object is valid if the moving direction, the moving speed, the swipe distance, the interaction duration and the hovering start duration all satisfy constraint conditions of the swipe interaction.

In some embodiments, if the interaction category includes grab-and-release interaction, the extracted key point information includes:
a hovering start duration, a changing behavior of the object at the minimum-depth position of movement during collision, and an interaction duration.

In some embodiments, the processor 1300 is configured to determine whether the interaction behavior of the object is valid by:
determining that the interaction behavior of the object is valid if the interaction duration, the hovering start duration and the changing behavior of the object all satisfy constraint conditions of the grab-and-release interaction.

Based on the same inventive concept, embodiments of the disclosure further provide an object interaction apparatus of stereoscopic space. Since this apparatus is the apparatus in the method in the embodiments of the disclosure and the principle of this apparatus to solve the problem is similar to that of the method, the implementations of this apparatus can refer to the implementations of the method, and the repeated description thereof will be omitted.

As shown in FIG. 14, this apparatus includes:
an information collection unit 1400 configured to collect interaction information between an object and display content in an interactive stereoscopic space, where the interaction information represents a behavior trajectory of an interaction behavior between the object and the display content;
an information extraction unit 1401 configured to extract key point information of the object in different interaction stages from the interaction information, where the key point information is used to reflect a behavior feature of the interaction behavior; and
a validity determining unit 1402 configured to determine whether the interaction behavior of the object is valid according to the key point information.

In some embodiments, the interaction information includes at least two of:
a first parameter set of the object in an interaction preparation stage, where the first parameter set includes hovering start information of the object;
a second parameter set of the object in an interaction occurrence stage, where the second parameter set includes collision information of the object and the display content, a moving direction and a moving speed of the object relative to the display content, and a changing behavior of the object during interaction; and
a third parameter set of the object in an interaction ending stage, where the third parameter set includes turning-back trajectory information of the object after collision ends.

In some embodiments, the information extraction unit 1401 is configured to: extract at least one of a hovering start position and a hovering start duration from the first parameter set;
extract at least one of a collision start position, a depth change during collision, a minimum-depth position of movement during collision, a farthest position of movement during collision, a collision end position, a movement end position, a collision duration, a moving direction, a moving speed, and a changing behavior of the object at the minimum-depth position from the second parameter set; where the depth change represents a change in distance of the object from a display screen during collision; and
extract a hovering end position and an interaction duration from the third parameter set, where the hovering end position is a position of the object closest to the hovering start position in a turning-back trajectory after collision ends.

In some embodiments, the validity determining unit 1402 is configured to:
determine an interaction category of the interaction behavior of the object according to the interaction information;
extract key point information corresponding to the interaction category in different interaction stages from the interaction information; and
determine whether the interaction behavior of the object is valid according to whether the extracted key point information satisfies a constraint condition corresponding to the interaction category.

In some embodiments, the validity determining unit 1402 is configured to:
determine a first behavior parameter and a second behavior parameter according to the key point information, where the first behavior parameter represents a parameter for position constraint on the interaction behavior from a spatial dimension, and the second behavior parameter represents a parameter for time constraint on the interaction behavior from a time dimension; and
determine whether the interaction behavior of the object is valid according to whether the first behavior parameter and the second behavior parameter satisfy the constraint condition.

In some embodiments, if the interaction category includes collision interaction, the extracted key point information includes:
a hovering start position and a hovering start duration;
at least two of a collision start position, a depth change during collision, a minimum-depth position of movement during collision, a farthest position of movement during collision, a collision end position, and a collision duration; and
a hovering end position and an interaction duration.

In some embodiments, if the collision interaction is single click or long press, the validity determining unit 1402 is configured to determine whether the interaction behavior of the object is valid by:
determining a collision distance according to the collision start position and the collision end position;
determining a hovering distance according to the hovering start position and the hovering end position; and
determining that the interaction behavior of the object is valid if the depth change during collision, the collision distance, the hovering distance, the hovering start duration, the collision duration and the interaction duration all satisfy constraint conditions of the single click or long press.

In some embodiments, if the collision interaction is double click, the validity determining unit 1402 is configured to determine whether the interaction behavior of the object is valid by:
determining a collision distance according to the collision start position and the collision end position;
determining a hovering distance according to the hovering start position and the hovering end position;
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy constraint conditions of the double click.

In some embodiments, if the collision interaction is zoom, the validity determining unit 1402 is configured to determine whether the interaction behavior of the object is valid by:
determining a first hovering start position, a first collision start position, a first farthest position of movement during collision, a first depth change during collision and a first hovering start duration according to an interaction behavior corresponding to a finger of the object;
determining a second hovering start position, a second collision start position, a second farthest position of movement during collision, a second depth change during collision and a second hovering start duration according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration and the second hovering start duration all satisfy constraint conditions of the zoom.

In some embodiments, if the interaction category includes swipe interaction, the extracted key point information includes:
a hovering start position, a hovering start duration, a moving direction, a moving speed, a moving end position and an interaction duration.

In some embodiments, the validity determining unit 1402 is configured to determine whether the interaction behavior of the object is valid by:
determining a swipe distance according to the hovering start position and the moving end position; and
determining that the interaction behavior of the object is valid if the moving direction, the moving speed, the swipe distance, the interaction duration and the hovering start duration all satisfy constraint conditions of the swipe interaction.

In some embodiments, if the interaction category includes grab-and-release interaction, the extracted key point information includes:
a hovering start duration, a changing behavior of the object at the minimum-depth position of movement during collision, and an interaction duration.

In some embodiments, the validity determining unit 1402 is configured to determine whether the interaction behavior of the object is valid by:
determining that the interaction behavior of the object is valid if the interaction duration, the hovering start duration and the changing behavior of the object all satisfy constraint conditions of the grab-and-release interaction.

Based on the same inventive concept, embodiments of the disclosure provide a computer storage medium, including a computer program code, which causes a computer to perform any object interaction method of stereoscopic space discussed above when running on the computer. Since the principle of the above-mentioned computer storage medium to solve the problem is similar to that of the object interaction method of stereoscopic space, the implementations of the above-mentioned computer storage medium can refer to the implementations of the method, and the repeated description thereof will be omitted.

In a specific implementation process, the computer storage medium may include: Universal Serial Bus (USB) flash drive, mobile hard disk, Read-Only Memory (ROM), Random Access Memory (RAM), magnetic disk or compact disc or various storage media that can store the program codes.

Based on the same inventive concept, embodiments of the disclosure further provide a computer program product, including a computer program code, which causes a computer to perform any object interaction method of stereoscopic space discussed above when running on the computer. Since the principle of the above-mentioned computer program product to solve the problem is similar to that of the object interaction method of stereoscopic space, the implementations of the above-mentioned computer program product can refer to the implementations of the method, and the repeated description thereof will be omitted.

The computer program product may use any combination of one or more readable media. The readable medium may be a readable signal medium or a readable storage medium. The readable storage medium may be, for example but not limited to, electrical, magnetic, optical, electromagnetic, infrared, or semiconductor system, apparatus or device, or any combination thereof. More specific examples of the readable storage media (non-exhaustive list) include: electrical connection with one or more wires, portable disk, hard disk, Random Access Memory (RAM), Read Only Memory (ROM), Erasable Programmable Read Only Memory (EPROM) or flash memory, optical fiber, portable Compact Disk-Read Only Memory (CD-ROM), optical storage device, magnetic storage device, or any suitable combination thereof.

It should be understood by those skilled in the art that the embodiments of the disclosure can be provided as methods, systems and computer program products. Thus the disclosure can take the form of hardware embodiments alone, software embodiments alone, or embodiments combining the software and hardware aspects. Also the disclosure can take the form of computer program products implemented on one or more computer usable storage mediums (including but not limited to magnetic disk memories, optical memories and the like) containing computer usable program codes therein.

The disclosure is described by reference to the flow charts and/or the block diagrams of the methods, the devices (systems) and the computer program products according to the embodiments of the disclosure. It should be understood that each process and/or block in the flow charts and/or the block diagrams, and a combination of processes and/or blocks in the flow charts and/or the block diagrams can be implemented by the computer program instructions. These computer program instructions can be provided to a general-purpose computer, a dedicated computer, an embedded processor, or a processor of another programmable data processing device to produce a machine, so that an apparatus for implementing the functions specified in one or more processes of the flow charts and/or one or more blocks of the block diagrams is produced by the instructions executed by the computer or the processor of another programmable data processing device.

These computer program instructions can also be stored in a computer readable memory which is capable of guiding the computer or another programmable data processing device to operate in a particular way, so that the instructions stored in the computer readable memory produce a manufacture including the instruction apparatus which implements the functions specified in one or more processes of the flow charts and/or one or more blocks of the block diagrams.

These computer program instructions can also be loaded onto the computer or another programmable data processing device, so that a series of operation steps are performed on the computer or another programmable device to produce the computer-implemented processing. Thus the instructions executed on the computer or another programmable device provide steps for implementing the functions specified in one or more processes of the flow charts and/or one or more blocks of the block diagrams.

Evidently those skilled in the art can make various modifications and variations to the disclosure without departing from the spirit and scope of the disclosure. Thus the disclosure is also intended to encompass these modifications and variations to the disclosure as long as these modifications and variations come into the scope of the claims of the disclosure and their equivalents.

1.-16. (canceled)

17. An object interaction method of stereoscopic space, comprising:
collecting interaction information between an object and display content in an interactive stereoscopic space, wherein the interaction information represents a behavior trajectory of an interaction behavior between the object and the display content;
extracting key point information of the object in different interaction stages from the interaction information, wherein the key point information is used to reflect a behavior feature of the interaction behavior; and
determining whether the interaction behavior of the object is valid according to the key point information.

18. The method according to claim 17, wherein the interaction information comprises at least two of:
a first parameter set of the object in an interaction preparation stage, wherein the first parameter set comprises hovering start information of the object;
a second parameter set of the object in an interaction occurrence stage, wherein the second parameter set comprises collision information of the object and the display content, a moving direction and a moving speed of the object relative to the display content, and a changing behavior of the object during interaction; and
a third parameter set of the object in an interaction ending stage, wherein the third parameter set comprises turning-back trajectory information of the object after collision ends.

19. The method according to claim 18, wherein said extracting the key point information of the object in different interaction stages from the interaction information, comprises:
extracting at least one of a hovering start position and a hovering start duration from the first parameter set;
extracting at least one of a collision start position, a depth change during collision, a minimum-depth position of movement during collision, a farthest position of movement during collision, a collision end position, a movement end position, a collision duration, the moving direction, the moving speed, and a changing behavior of the object at the minimum-depth position from the second parameter set; wherein the depth change represents a change in distance of the object from a display screen during collision; and
extracting a hovering end position and an interaction duration from the third parameter set, wherein the hovering end position is a position of the object closest to the hovering start position in a turning-back trajectory after collision ends.

20. The method according to claim 17, wherein said determining whether the interaction behavior of the object is valid according to the key point information, comprises:
determining an interaction category of the interaction behavior of the object according to the interaction information;
extracting key point information corresponding to the interaction category in different interaction stages from the interaction information; and
determining whether the interaction behavior of the object is valid according to whether the extracted key point information satisfies a constraint condition corresponding to the interaction category.

21. The method according to claim 20, wherein said determining whether the interaction behavior of the object is valid according to whether the extracted key point information satisfies the constraint condition corresponding to the interaction category, comprises:
determining a first behavior parameter and a second behavior parameter according to the key point information, wherein the first behavior parameter represents a parameter for position constraint on the interaction behavior from a spatial dimension, and the second behavior parameter represents a parameter for time constraint on the interaction behavior from a time dimension; and
determining whether the interaction behavior of the object is valid according to whether the first behavior parameter and the second behavior parameter satisfy the constraint condition.

22. The method according to claim 20, wherein if the interaction category comprises collision interaction, the extracted key point information comprises:
a hovering start position and a hovering start duration;
at least two of a collision start position, a depth change during collision, a minimum-depth position of movement during collision, a farthest position of movement during collision, a collision end position, and a collision duration; and
a hovering end position and an interaction duration.

23. The method according to claim 22, wherein if the collision interaction is single click or long press, whether the interaction behavior of the object is valid is determined by:
determining a collision distance according to the collision start position and the collision end position;
determining a hovering distance according to the hovering start position and the hovering end position; and
determining that the interaction behavior of the object is valid if the depth change during collision, the collision distance, the hovering distance, the hovering start duration, the collision duration and the interaction duration all satisfy the constraint condition of the single click or long press.

24. The method according to claim 22, wherein if the collision interaction is double click, whether the interaction behavior of the object is valid is determined by:
determining a collision distance according to the collision start position and the collision end position;
determining a hovering distance according to the hovering start position and the hovering end position; and
determining a double-click distance according to minimum-depth positions of movements during collisions with different moving trajectories; and
determining that the interaction behavior of the object is valid if the depth change during collision, the collision distance, the hovering distance, the double-click distance, the hovering start duration, the collision duration and the interaction duration all satisfy the constraint condition of the double click.

25. The method according to claim 22, wherein if the collision interaction is zoom, whether the interaction behavior of the object is valid is determined by:
determining a first hovering start position, a first collision start position, a first farthest position of movement during collision, a first depth change during collision and a first hovering start duration according to an interaction behavior corresponding to a finger of the object;
determining a second hovering start position, a second collision start position, a second farthest position of movement during collision, a second depth change during collision and a second hovering start duration according to an interaction behavior corresponding to another finger of the object;
determining a hovering distance according to the first hovering start position and the second hovering start position;
determining a collision distance according to the first collision start position and the second collision start position;
determining a distance between two fingers according to the first farthest position and the second farthest position; and
determining that the interaction behavior of the object is valid if the hovering distance, the collision distance, the distance between two fingers, the first depth change, the second depth change, the first hovering start duration and the second hovering start duration all satisfy the constraint condition of the zoom.

26. The method according to claim 20, wherein if the interaction category comprises swipe interaction, the extracted key point information comprises:
a hovering start position, a hovering start duration, a moving direction, a moving speed, a moving end position and an interaction duration.

27. The method according to claim 26, wherein whether the interaction behavior of the object is valid is determined by:
determining a swipe distance according to the hovering start position and the moving end position; and
determining that the interaction behavior of the object is valid if the moving direction, the moving speed, the swipe distance, the interaction duration and the hovering start duration all satisfy the constraint condition of the swipe interaction.

28. The method according to claim 20, wherein if the interaction category comprises grab-and-release interaction, the extracted key point information comprises:
a hovering start duration, a changing behavior of the object at a minimum-depth position of movement during collision, and an interaction duration.

29. The method according to claim 28, wherein whether the interaction behavior of the object is valid is determined by:
determining that the interaction behavior of the object is valid if the interaction duration, the hovering start duration and the changing behavior of the object all satisfy the constraint condition of the grab-and-release interaction.

30. A display device, comprising a display screen and a controller, wherein:
the display screen is configured to display content in an interactive stereoscopic space; and
the controller is configured to perform:
collecting interaction information between an object and display content in an interactive stereoscopic space, wherein the interaction information represents a behavior trajectory of an interaction behavior between the object and the display content;
extracting key point information of the object in different interaction stages from the interaction information, wherein the key point information is used to reflect a behavior feature of the interaction behavior; and
determining whether the interaction behavior of the object is valid according to the key point information.

31. An electronic device, comprising a processor and a memory, wherein the memory is configured to store a program executable by the processor, and the processor is configured to read the program in the memory and perform the method according to claim 17.

32. A computer storage medium storing a computer program, wherein the computer program implements the method of claim 17 when executed by a processor.
